(19) United States
(12) Patent Application Publication
(10) Pub. No.: US 2006/0168891 A1
(43) Pub. Date: Aug. 3, 2006

(54) Vehicle door opening and closing apparatus

(75) Inventors: Nobuo Aoyama, Anjo-shi (JP); Daisuke Toyama, Anjo-shi (JP); Nobuhiro Yamauchi, Chiryu-shi (JP)

Correspondence Address: BUCHANAN INGERSOLL PC;(INCLUDING BURNS, DOANE, SWECKER & MATHIS), POST OFFICE BOX 1404, ALEXANDRIA, VA, 22313-1404, US

(73) Assignee: AISIN SEIKI KABUSHIKI KAISHA, Kariya-shi (JP)

(21) Appl. No.: 11/337,547

(22) Filed: Jan. 24, 2006

(30) Foreign Application Priority Data
Jan. 28, 2005 (JP) 2005-022213

(51) Int. Cl. E05F 11/00; B60J 5/06; G05B 5/00

(52) U.S. Cl. 49/360; 49/280; 318/446; 296/155

(57) ABSTRACT

When an ECU interrupts electric power supplying to an electromagnetic coil with a rotor, a rotor and an armature are controlled at a disconnected state, in which a driving force transmission between a vehicle door and a electric driving power source is interrupted and a manual opening and closing operation of the vehicle door is allowed. When the ECU supplies electric power to the electromagnetic coil, the rotor and the armature are controlled at a connected state, in which the driving force transmission between the vehicle door and the electric driving power source is performed. After the ECU activates the electric driving power source to perform one of an opening operation, and a closing operation, of the vehicle door, the ECU interrupts electric power supplying to the electromagnetic coil and activates the electric driving power source.

### CROSS REFERENCE TO RELATED APPLICATIONS

This application is based on and claims priority under 35 U.S.C. §119 with respect to Japanese Patent Application 2005-022213, filed on Jan. 28, 2005 the entire content of which is incorporated herein by reference.

### FIELD OF THE INVENTION

This invention generally relates to a vehicle door opening and closing apparatus.

### BACKGROUND

Conventionally, various types of vehicle door opening and closing apparatus, which electrically opens and closes a slide door of a vehicle such as an automobile, have been proposed. These vehicle door opening and closing apparatus are provided with a driving power source electrically driven so as to slidably move a slide door. An electromagnetic clutch device is provided between the slide door and the driving power source and switches a state, in which a driving force transmission is established between the driving power source and the slide door, and a state, in which a driving force transmission is discontinued between the driving power source and the slide door. When an electric opening and closing operation of the slide door is required, a driving force of the driving power source is transmitted to the slide door by the electromagnetic clutch device, and the slide door can be opened or closed electrically. On the other hand, when a manual opening and closing operation of the slide door is required, the electromagnetic clutch device discontinues a driving force transmission between the driving power source and the slide door, and the slide door can be opened or closed manually.

For example, JP2001-41263A (FIG. 1) discloses an electromagnetic clutch device, which is applicable to a vehicle door opening and closing apparatus such as described above. This electromagnetic clutch device includes a rotor, an armature and an electromagnetic coil. When the electromagnetic coil is electrically energized or distributed with electric power, the rotor and the armature are connected to each other via a magnetic field formed by the electromagnetic coil, wherein a driving force transmission between the rotor and the armature is allowed. On the other hand, when the electric energizing of the electromagnetic coil is discontinued, the rotor and the armature are disconnected from each other, wherein a driving force transmission between the rotor and the armature is prohibited. By applying this type of electromagnetic clutch device to a vehicle door opening and closing apparatus such as described above, a driving force transmission between the driving power source and the slide door is switched.

Here, the rotor and the electromagnetic coil are structurally integrated, which can eliminate an airgap which is needed in circumstances where the electromagnetic coil is mounted outside of the rotor such as at a housing and is formed between the rotor and the electromagnetic coil to allow the rotor to revolve freely. In this case, it is possible to reduce magnetic loss. Therefore, it is possible to enhance a transmission torque of the electromagnetic clutch device or to downsize the electromagnetic coil in response to improvement in a magnetic efficiency.

Meanwhile, because such airgap can be eliminated, remanent magnetic flux, which on occasions linger after discontinuing electric power distribution to the electromagnetic coil, may exercise its influence. According to the electromagnetic clutch device disclosed herein, a magnetic circuit established between the armature and an integral configuration having the rotor and the electromagnetic coil is a magnetic loop. In this case, compared with an electric circuit having an airgap, magnetic flux attenuation, which should occur after discontinuing eclectic power distribution to the electromagnetic coil, may be interrupted or may be restrained. More over, due to influences of the remanent magnetic flux, a connection between S the rotor and the armature may be maintained. Therefore, when the slide door, which had opened or closed electrically, is then closed or opened manually, the electromagnetic clutch device is still at a connected state due to such remanent magnetic flux, in other words, an output side (a door side) has still been connected to the drive power source, wherein an operation of an output side (a door side) may be applied with an unexpectedly lard load. In this case, it may increase an operation force required to operate the slide door and damage an operation feeling that a driver or an operator would have.

The present invention has been made in view of the above circumstances, and provides a vehicle door opening and closing apparatus which can improve a manual opening and closing performance of a vehicle door after an electrically-driven closing and opening operation of the vehicle door.

### SUMMARY OF THE INVENTION

According to an aspect of the present invention, a vehicle door opening and closing apparatus includes: an electric driving power source configured to generate a driving force that performs an opening operation, and a closing operation, of a vehicle door; an electromagnetic clutch device positioned between the vehicle door and the electric driving power source and configured to selectively perform and interrupt a driving force transmission between the vehicle door and the electric driving power source; and an ECU for controlling the driving power source and the electromagnetic clutch device. The electromagnetic clutch device includes: a rotor; an electromagnetic coil integrated with the rotor; and an armature. When the ECU interrupts power supply to the electromagnetic coil, the rotor and the armature are controlled at a disconnected state, in which the driving force transmission between the vehicle door and the electric driving power source is interrupted and a manual opening and closing operation of the vehicle door is allowed. When the ECU supplies electric power to the electromagnetic coil, the rotor and the armature are controlled at a connected state, in which the driving force transmission between the vehicle door and the electric driving power source is performed. After the ECU(controller) activates the electric driving power source to perform one of the opening operation, and the closing operation of the vehicle door, the ECU interrupts electric power supplying to the electromagnetic coil and activates the electric driving power source.

For example, after the ECU activates the electric driving power source so as to carry out the one of the opening and closing operations of the vehicle door, the ECU can interrupt electric supply to the electromagnetic coil and activates the electric driving power source so as to carry out an other one of the opening and closing operations of the vehicle door.

### BRIEF DESCRIPTION OF THE DRAWINGS

The foregoing and additional features and characteristics of the present invention will become more apparent from the following detailed description considered with reference to the accompanying drawings, wherein:

FIG. 1 is a block view schematically illustrating an electric structure of a vehicle door opening and closing apparatus according to an embodiment of the present invention;

FIG. 2 is a side view illustrating a vehicle such as an automobile, which is applied with the vehicle door opening and closing apparatus according to the embodiment of the present invention;

FIG. 3 is a cross sectional view illustrating a structure of an actuator;

FIG. 4 is a timechart for explaining control of a closing operation of a vehicle door;

FIG. 5 is a timechart for explaining control of an opening operation of the vehicle door,

FIG. 6 is a flowchart for explaining an operation of the vehicle door from a fully open position to a fully closed position;

FIG. 7 is a flowchart for explaining an operation of the vehicle door from the fully closed position to the fully open position; and

FIG. 8 is a timechart for explaining control of an opening operation of the vehicle door according to an alternative example.

### DETAILED DESCRIPTION

An embodiment of the present invention will be described hereinbelow in detail with reference to the accompanying drawings.

As illustrated in FIG. 2, a slide door 1 as a vehicle door is fixed to a side surface of a vehicle body 2 by an upper guide rail 3, a lower guide rail 4 and a center guide rail 5 and is supported freely slidably in a longitudinal direction of a vehicle relative to the vehicle body 2. An opening 2a, which is formed at the vehicle body 2 and is utilized for an occupant to get on, and off the vehicle, is opened and closed in response to a slidable movement (a sliding operation) of the slide door 1 relative to the vehicle body 2.

The slide door 1 is provided with a drive unit 6 for slidably operating the slide door 1, the drive unit 6 which is configured with an actuator 7 having a drive motor 71 (i.e., an electric driving power source) and an output drum 72, two cables 81 and 82, and a guide pulley 9. The drive motor 71 and the output drum 72 are mutually associated via a speed reduction mechanism and an electromagnetic clutch 20, both which are described later. One ends of the cables 81 and 82 are wound and fixed to the output drum 72 of the actuator 7, while the other ends thereof are guided by the guide pulley 9 and the center guide rail 5 and fixed to the vehicle body 2.

According to the actuator 7 structured described above, when the output drum 72 is rotated in one direction in response to activation of the drive motor 71, the cable 81, out of the cables 81 and 82, is retracted by the output drum 72 and the other cable 82 is fed out from the output drum 72. As a consequence, the slide door 1 is operated in an opening direction (an opening operation). On the other hand, when the output drum 72 is rotated in a reverse direction in response to activation of the drive motor 71, the cable 81 is fed out from the output drum 72 and the other cable 82 is retracted by the output drum 72. As a consequence, the slide door 1 is operated in a closing direction (a closing operation).

The electromagnetic clutch device 20 is positioned in a driving force transmitting path between the drive motor 71 and the output drum 72, in details, between the speed reduction mechanism and the output drum 72. The electromagnetic clutch device 20 switches a connected state, in which a driving force transmission between the drive motor 71 and the output drum 72 is carried out, and a disconnected state, in which the driving force transmission is disabled or discontinued. Therefore, for example when a sliding operation of the slide door 1 by use of a driving force of the drive motor 71 is required, the electromagnetic clutch device 20 is controlled to establish the connected state. On the other hand, when a manual sliding operation of the slide door 1 is required, the electromagnetic clutch device 20 is controlled to establish the disconnected state, wherein a manual opening and closing operation of the slide door 1 is carried out.

The slide door 1 is further provided with a lock device 31 which includes a latch mechanism having a latch and a pole. When the slide door 1 is located at a half-closed position, i.e., at a half-latch position, the latch mechanism is able to lock the slide door 1 by being engaged with an engagement member (a striker) attached to the vehicle body 2. That is, the lock device 31 is able to lock the slide door 1 when the latch is rotated and is engaged with the engagement member, and, at or about the same time, the pole interrupts a further rotation of the latch. Once the pole is operated and allows a further rotation of the latch, the latch is released from being engaged with the engagement member. In this case, the lock device 31 can unlock the slide door 1.

The slide door 1 is shifted from the half-closed position, i.e., the half-latch position to a fully closed position in conformity with a lock operation of the lock device 31, i.e., in conformity with a rotation of the latch while the door being at a half open position. Here, the slide door 1 is operated like being drawn or pulled towards an inside of a vehicle compartment. On the other hand, the slide door 1 is shifted from a fully closed position to a half open position in conformity with an unlock operation of the lock device 31, i.e., in conformity with a further rotation of the latch allowed by the pole. Here, the slide door 1 is operated like being drawn out or pulled out towards an outside of the vehicle body 2.

Next, described below is the structure, and function, of the actuator 7, more specifically, the structure of the electromagnetic clutch device 20.

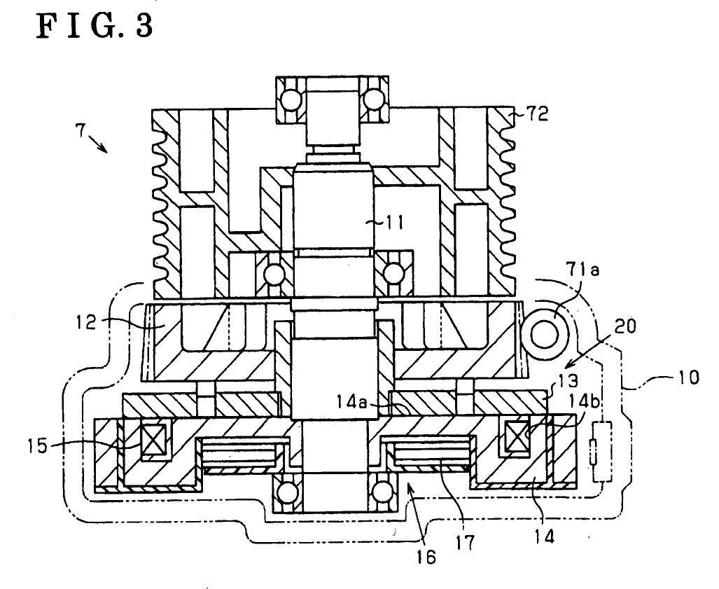

As illustrated in FIG. 3, this actuator 7 is provided with a housing 10 (a body of equipment), a worm gear 71a fastened to a rotational shaft of the drive motor 71, a rotational shaft 11 fixedly attached with the output drum 72, a wheel gear 12 gear-meshed with the worm gear 71a, an armature 13, a rotor 14, a ring-shaped electromagnetic coil 15 and a power supply mechanism 16. The electromagnetic clutch device 20 is primarily configured with the armature 13, the rotor 14, the ring-shaped electromagnetic coil 15 and the power supply mechanism 16.

The rotational shaft 11 is freely rotatably supported by the housing 10. The wheel gear 12 is relatively rotatably supported about the rotational shaft 11. The output drum 72 is fixed to the rotational shaft 11 so as to rotate integrally therewith. The speed reduction mechanism is primarily configured with the worm gear 71a and the wheel gear 12.

The armature 13 is made of a magnetic material and is formed to be a substantially disc-shaped structure. The armature 13 is relatively rotatably supported about the rotational shaft 11 and is connected to the wheel gear 12 so as to integrally rotate with the wheel gear 12.

The rotor 14 is also made of a magnetic material and is formed to be a substantially disc-shaped structure, an outer diameter of which is substantially the same as an outer diameter of the armature 13. The rotor 14 is positioned to face the armature 13 and is fixedly attached to the rotational shaft 11 so as to rotate integrally with the rotational shaft 11. A frictional plate is provided or laid at a surface 14a (a frictional contact surface, an upper surface in FIG. 3), which is positioned at an axially one side of the rotor 14 and faces the armature 13. Therefore, the rotor 14 and the armature 13 can be frictionally come in contact with each other via this frictional plate. For example when the rotor 14 and the armature 13 is frictionally come in contact with each other (a connected state), the electromagnetic clutch device 20 is engaged. On the other hand, when the frictional contact between the rotor 14 and the armature 13 is discontinued (a disconnected state), the electromagnetic clutch device 20 is disengaged.

A ring-shaped groove 14b, which is recessed substantially in parallel with an axial direction of the rotor 14, is formed at the surface 14a facing the armature 13. The electromagnetic coil 15 is housed in the ring-shaped groove 14b and is integrated with the rotor 14 so as to integrally rotate with the rotor 14. When the electromagnetic coil 15 is electrically energized, the rotor 14 and the armature 13 is brought into a connected state, while, when the electromagnetic clutch 15 is not energized, the rotor 14 and the armature 13 is brought into a disconnected state.

The power supply mechanism 16 includes a wire harness 17 wound to be a spiral. This wire harness 17 is made from, for example an FFC (i.e., a Flexible Flat Cable) or an FPC (i.e., a Flexible Printed Circuit) so that it is deformable. One end of the wire harness 17, which is positioned at an outer diameter side, is electrically connected to the electromagnetic coil 15 housed in the rotor 14, and the other end of the wire harness 17, which is positioned at an inner diameter side, is electrically connected to a control unit (described later) in the slide door 1. Therefore, when the rotor 14 and the electromagnetic coil 15 are rotated, the wire harness 17 is retracted or fed out. The operation of the wire harness 17 is hence allowed to conform to a rotation of the rotor 14 and the electromagnetic coil 15 at a predetermined rotational angle range. This rotational angle range can be predetermined on the basis of a rotational angle range of the drive motor 71 that is required for opening and closing the slide door 1.

In circumstances where the connected state between the rotor 14 and the armature 13 is established and the electromagnetic clutch 20 is at an engaged condition, when the drive motor 71 is driven for the purpose of opening or closing the slide door 1, the wheel gear 12 is rotated and the armature 13 is rotated. Because the armature 13 is frictionally in contact with the rotor 14, the rotation of the armature 13 is transmitted to the rotor 14, wherein the rotor 14 starts rotating. The rotation of the rotor 14 is transmitted to the rotational shaft 1I fixedly equipped with the output drum 72, wherein the rotational shaft 11 and the output drum 72 start rotating. Accordingly, the slide door 1 is opened or closed in response to movements of the cables 81 and 82.

On the other hand, in circumstances where the disconnected state between the rotor 14 and the armature 13 is established and the electromagnetic clutch 20 is at a disengaged condition, when the output drum 72 is rotated via the movements of the cables 81 and 82 in response to the opening or closing operation of the slide door 1, the rotational shaft 11 and the rotor 14 start rotating. In this case, the rotation of the rotor 14 is not transmitted to the armature 13, so that the rotor 14 slips against the armature 13. As a consequence, the output drum 72 is allowed to smoothly rotate and a manual opening and closing operation of the slide door 1 is carried out.

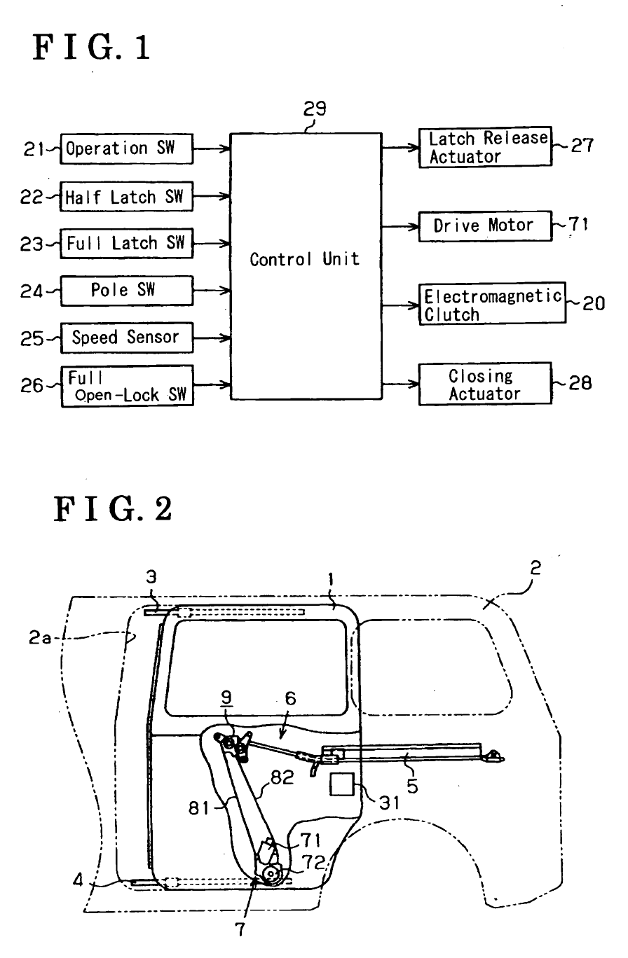

Next, described below is an electric structure of the vehicle door opening and closing apparatus, with reference to FIG. 1.

As is apparent from FIG. 1, the vehicle door opening and closing apparatus according to the embodiment of the present invention is provided with an operation switch 21, a half latch switch 22, a full latch switch 23, a pole switch 24, a speed sensor 25 and a full open lock switch 26. The vehicle door opening and closing apparatus is further provided with the drive motor 71, the electromagnetic clutch device 20 (the actuator 7), a latch release actuator 27, a closing actuator 28 and a control unit (hereinafter, referred to as an ECU) 29.

The operation switch 21 outputs a signal to the ECU 29, the signal which represents a requirement, or necessity, of an electrically driven opening and closing operation of the slide door 1. The operation switch 21 can be located near or ahead of a driver's seat for example. This operation switch 21 is turned on when an opening or closing operation of the slide door 1 is required. On the other hand, the operation switch 21 is turned off when there is no need to open and close the slide door 1, i.e., when it is not operated.

The half latch switch 22 outputs a signal to the ECU 29, the signal which is employed so as to detect, on the basis of a position of the latch of the lock device 31, whether the slide door 1 is at the half-closed position (the same as the half-pen position). The half latch switch 22 is controlled at an on state (off-→n) when the slide door 1 is positioned within a range between a fully open position and a position, the position which is closer, by a predetermined amount, to the fully open position relative to a half-closed position, inclusive. On the other hand, the half latch switch 22 is controlled at an off state (on→off) when the slide door 1 is positioned outside the aforementioned range.

The full latch switch 23 outputs a signal to the ECU 29, the signal which is employed so as to detect, on the basis of a position of the latch of the lock device 31, whether the slide door 1 is at a fully closed position. The fall latch switch 23 is controlled at an on state (off→on) when the slide door 1 is positioned within a range between the fully open position and a position, which is slightly opened from the fully closed position. On the other hand, the full latch switch 23 is controlled at an off state (on→off) when the slide door 1 is positioned outside the aforementioned range.

The pole switch 24 outputs a signal to the ECU 29, the signal which represents a position of the pole of the lock device 31. The pole switch 24 is controlled at an on state (off→on) while the slide door 1 is at the half-closed position and the fully closed position. On the other hand, the pole switch 24 is controlled at an off state (on→off) while the latch is rotating.

The speed sensor 25 outputs an on→off pulse signal to the ECU 29 in response to rotation of the drive motor 71 every predetermined rotational angle. Once the ECU 29 receives an output on→off pulse signal of the speed sensor 25, the ECU 29 detects an opening and closing position, and an opening and closing speed, of the slide door 1.

The fully open lock switch 26 output s a signal to the ECU 29, the signal which represents a position of the slide door 1. The fully open lock switch 26 is controlled at an on state (off→on) where the slide door 1 is located at the fully open position, while the fully open lock switch 26 is controlled at an off state (on→off) when the slide door 1 is not positioned at the fully open position.

The latch release actuator 27 is provided with an electrically driven motor for example and is associated with the lock device 31. When the slide door 1 is at the fully closed position, the latch release actuator 27 operates the pole of the lock device 31 and encourages rotation of the latch, wherein the lock device 31 unlocks the slide door 1. In response to this unlock operation of the lock device 31, the slide door 31 is shifted from the fully closed position to the half-open position.

The closing actuator 28 is provided with an electrically driven motor for example and is associated with the lock device 31. When the slide door 1 is at the half-open position, the closing actuator 28 rotates the latch of the lock device 31 and engages the latch with the engagement member, wherein the lock device 31 locks the slide door 1.

The ECU 29 is primarily configured with a digital computer having a central processing unit (CPU), a Read-Only Memory (ROM) storing, therein, various programs and maps, a Random-Access Memory (RAM) storing, therein various data which can be read and written, and so on. The ECU 29 controls, on the basis of the output signals of the switches and sensors 21 to 26, driving of the actuator 7 (the drive motor 71 and the electromagnetic clutch device 20), the latch release actuator 27 and the closing actuator 28.

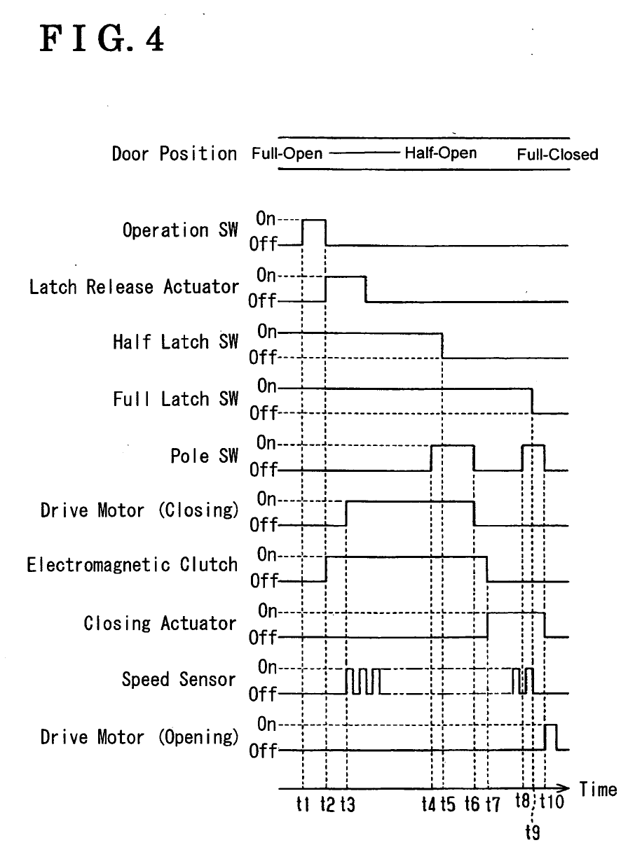

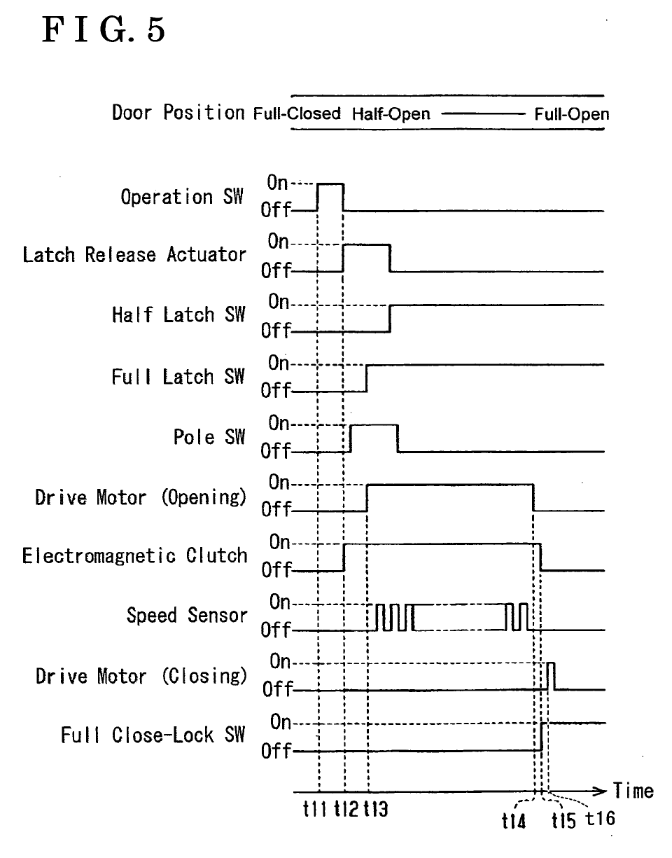

Next, described below are controls of an opening and closing operation of the slide door 1 with reference to FIGS. 4 and 5. The timechart illustrated in FIG. 4 explains transition, of output signals of the switches and sensors 21 to 26, and of drive signals to the drive motor 71, the electromagnetic clutch device 20, the latch release actuator 27 and the closing actuator 28, at a time that the slide door 1 is shifted from the fully open position to the fully closed position. The timechart illustrated in FIG. 5 explains transition thereof at a time that the slide door 1 is shifted from the fully closed position to the fully open position. In FIGS. 4 and 5, a signal, which the drive motor 71 receives for opening the slide door 1, is distinguished from a signal, which the drive motor 71 receives for closing the slide door 1. The drive motor 71 can be supplied with electric current, of which polarity is opposite to each other, in response to various drive signals of the ECU 29, and can be rotated in one rotational direction for opening the slide door 1 or in a reverse rotational direction for closing the slide door 1.

As is obvious from FIG. 4, while the slide door 1 is at the fully open position, when the operation switch 21 is turned on at time t1 in response to a requirement for closing the slide door 1, the ECU 29 then turns on a drive signal of the electromagnetic clutch device 20 in synch with turning off of the operation switch 21 at time t2. Here, the electromagnetic coil 15 is electrically energized, i.e., electric power is supplied to the electromagnetic coil 15, and the rotor 14 and the armature 13 are controlled at the connected state (disconnected→connected), wherein the electromagnetic clutch device 20 is engaged. In such circumstances, the ECU 29 turns on, at time t3, the drive signal of the drive motor 71 for implementing a closing operation of the slide door 1. Here, the drive motor 71 is rotated so as to implement the closing operation of the slide door 1.

In the course of the closing operation of the slide door 1, the slide door 1 is shifted to the half-open position. The pole switch 24 is then turned on at time t4. In a matter of time, the half latch switch 22 is turned off at time t5. The ECU 29 then turns off the drive signal of the drive motor 71 in synch with turning off of the pole switch 24 at time t6, wherein the drive motor 71 is terminated from being driven. And at time t7, the ECU 29 turns off the drive signal of the electromagnetic clutch 20. Accordingly, electric energizing or electric power distribution to the electromagnetic coil 15 is discontinued, and the electromagnetic clutch device 20 is disengaged. At time t7, the ECU 29 turns on the drive signal of the closing actuator 28. Therefore, the closing operation of the slide door 1 is shifted from the actuator 7 to the closing actuator 28. The lock device 31 locks the slide door 1 by the closing actuator 28 and the slide door 1 reaches the fully closed condition.

At time t8, the pole switch 24 is turned on, and at time t9, the full latch switch 23 is turned off. The ECU 29 then turns off the drive signal of the closing actuator 28 in synch with turning off of the pole switch 24 at time t10. Accordingly, the operation of the closing actuator 28 is terminated. At or about the same time, the ECU 29 turns on the drive signal of the drive motor 71, a drive signal which is employed to open the slide door 1, for a predetermined time (e.g., several msec), wherein the drive motor 71 is activated. Here, the rotor 14 and the armature 13, which have been maintained at the connected state due to remanent magnetic flux, is released from the connected state. Especially, because the drive motor 71 is driven in a reverse rotational direction corresponding to a door opening operation after the closing operation of the slide door 1, remanent load (creep load), which on occasions occurs at a closing operation of the slide door 1 and is applied to mechanically engagement elements associated with a driving force transmission between the drive motor 71 and the slide door 1, can be effectively reduced. For example, remanent load; which is applied to a gear unit configuring the speed reduction mechanism of the actuator 7, i.e., a gear-meshed portion between the worm gear 71a and the wheel gear 12, can be effectively reduced. Moreover, for example, remanent load, which is applied to cables and so on that transmit a driving force from the output drum 72 to the slide door 1, can be effectively reduced. Afterwards, the ECU 29 turns of a power source and terminates the system.

As is obvious from FIG. 5, while the slide door 1 is at the fully closed position, when the operation switch 21 is turned on at time t11 in response to a requirement for opening the slide door 1, the ECU 29 then turns on a drive signal of the latch release actuator 27 in synch with turning off of the operation switch 21 at time t12. Here, the lock device 31 unlocks the slide door 1 in response to driving of the latch release actuator 27, and the slide door 1 is shifted to the half-open position. At or about the same time, the ECU 29 turns on a drive signal of the electromagnetic clutch deice 20. Here, the electromagnetic coil 15 is electrically energized or distributed with electric power, and the rotor 14 and the armature 13 are brought into the connected state, wherein the electromagnetic clutch device 20 is engaged. In such circumstances, the ECU 29 turns on a drive signal of the drive motor 71, the drive signal which is employed to open the slide door 1. Here, the drive motor 71 is rotated so as to implement the opening operation of the slide door 1.

In the course of the opening operation of the slide door 1, when the slide door 1 comes close to the fully open position and the opening/closing speed of the slide door 1 on the basis of the on→off pulse signal of the speed sensor 25 becomes slow, the ECU 29 turns off, at time t14, the drive signal of the drive motor 71, wherein the drive motor 71 is discontinued from being activated. The opening/closing speed of the slide door 1 in the vicinity of the fully open position could be reduced or lowered on the basis of a known low-speed control implemented to reduce a degree of shock that may occur at the opening operation to the fully open position.

The ECU 29 turns off the drive signal of the electromagnetic clutch device 20 in synch with turning on the full lock switch 26 at time t15. Accordingly, electric energizing or electric power distribution to the electromagnetic coil 15 is discontinued, and the electromagnetic clutch device 20 is disengaged. And at time t16, the ECU 29 turns on a drive signal of the drive motor 71, the drive signal which is employed to close the slide door 1, for a predetermined time (e.g., several msec), wherein the drive motor 71 is activated. Here, the rotor 14 and the armature 13, which have been maintained at the connected state due to remanent magnetic flux, is released from the connected state. Especially, because the drive motor 71 is driven in a reverse rotational direction corresponding to a door closing operation after the opening operation of the slide door 1, remanent load (creep load), which on occasions occurs at an opening operation of the slide door 1 and is applied to mechanically engagement elements associated with a driving force transmission between the drive motor 71 and the slide door 1, can be effectively reduced. Afterwards, the ECU 29 turns off a power source and terminates the system.

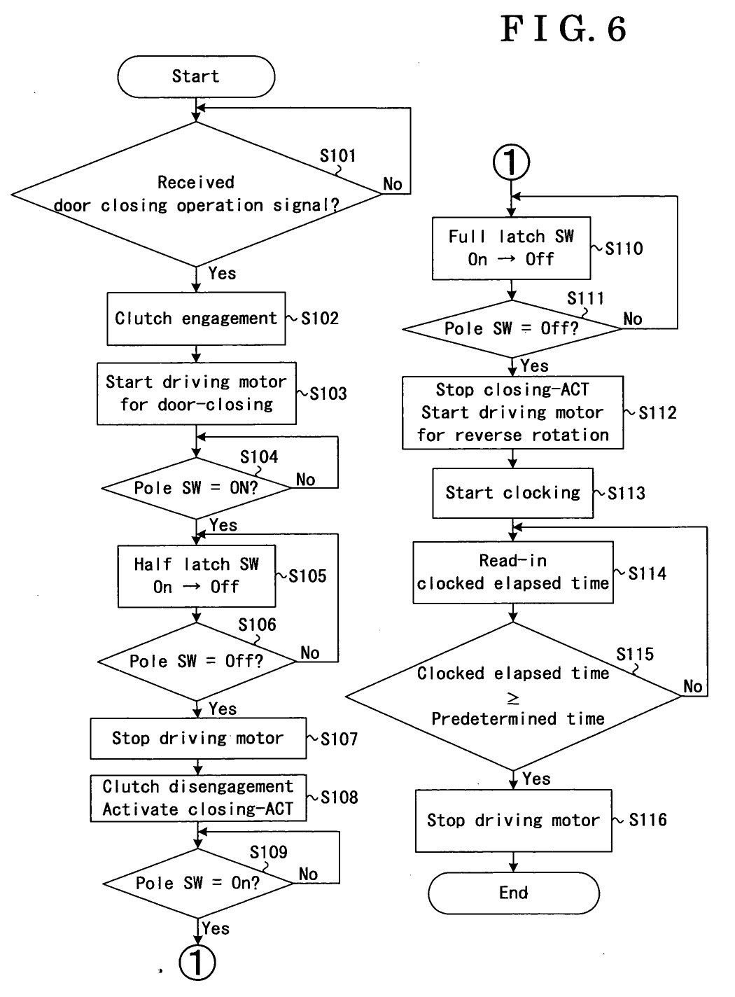

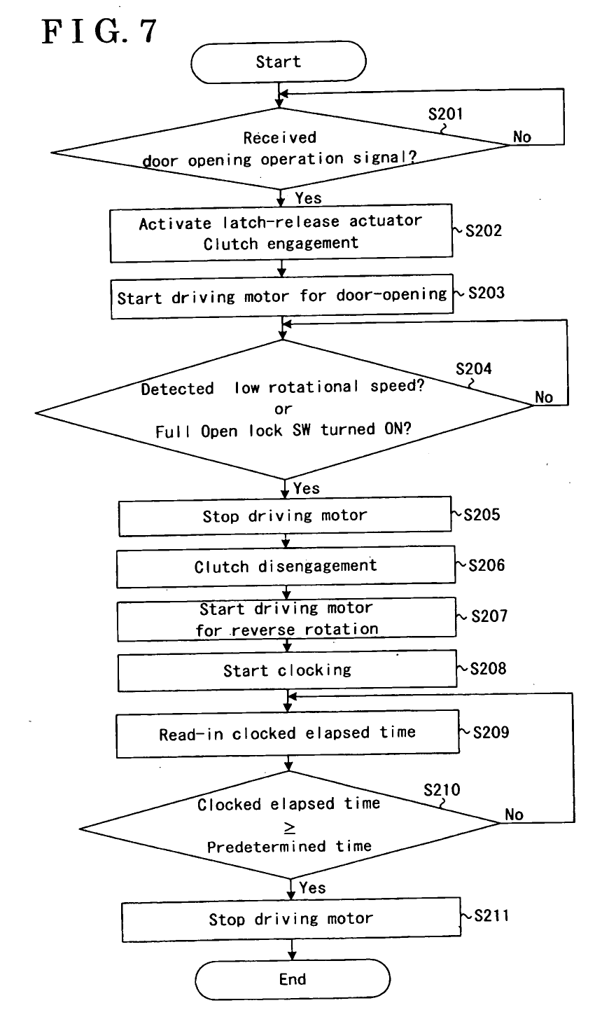

Next, described below is an operation for opening and closing the slide door 1 by the ECU 29 with reference to flowcharts in FIGS. 6 and 7.

Once the process to be implemented by the ECU 29 shifts to this routine illustrated in FIG. 6, the ECU 29 determines, in step S101, whether the ECU 29 has received output information of a door closing operation. More specifically, the ECU 29 determines the presence or absence (on or off) of an output signal of the operation switch 21, the signals which represent requirements of opening and closing of the slide door 1. When the ECU 29 receives the output signal of the operation switch 21, the program proceeds to step S102, wherein the electromagnetic clutch device 20 is engaged. That is, the ECU 29 electrically energizes or supplies electric power to the electromagnetic coil 15 of the electromagnetic clutch device 20, and the rotor 14 and the armature 13 are controlled at the connected state (disconnected→connected). The ECU 29 then activates the drive motor 71 in step S 103 so as to initiate a closing operation of the slide door 1. That is, in step S103, the ECU 29 controls the drive motor 71 to rotate in a rotational direction for closing the slide door 1.

In the course of the closing operation of the slide door 1 in response to a driving of the drive motor 71, the ECU 29 stands by, in step S104, for turning on of the pole switch 24. Once the pole switch 24 is turned one the program proceeds to step S105. After the shift of the half latch switch 22 from an on state to an off state, the program proceeds to step S106, wherein the ECU 29 stands by for turning off of the pole switch 24. In other words, in step S106, when the pole switch 24 is turned off during the closing operation of the slide door 1, the ECU 29 determines that the slide door 1 is at the half-closed position. Once the pole switch 24 is turned off in step S106, the program proceeds to step S107.

In step S107, the ECU 29 discontinues activation of the drive motor 71 for closing the slide door 1 and further disengages the electromagnetic clutch device 20. In step S108, the ECU 29 terminates electric energizing or electric power distribution to the electromagnetic coil 15 and brings the rotor 14 and the armature 13 to the disconnected state. At about the same time, the ECU 29 locks the lock device 31 and drives the closing actuator 28 to shift the slide door 1 from the half-closed position to the fully closed position.

Once the slide door 1 is shifted to the fully closed position in response to activation of the closing actuator 28, the ECU 29 stands by, in step S109, for turning on of the pole switch 24. Once the pole switch 24 is turned on in step S109, the program proceeds to step S110. After turning off of the full latch switch 23 in step S110, the ECU proceeds to step Sill and stands by for turning off of the pole switch 24. That is, the program proceeds to step S112 after turning off of the pole switch 24, i.e., after an identification of the slide door 1 reached at the fully closed position.

In step S112, the ECU 29 terminates the closing operation, i.e., terminates a driving of the closing actuator 28, the driving which is employed for operating the slide door 1 to the fully closed position. At or about the same time, the ECU 29 activates the drive motor 71 to rotate in a reverse rotational direction. That is, the ECU 29 activates the drive motor 71 to rotate for operating the slide door 1 towards an open side. Here, the reverse rotation of the drive motor 71 is carried out, inter alia, for the purpose of releasing the rotor 14 and the armature 13 from the connected state, the connected state which may have been maintained due to influences of remanent magnetic flux. Apart from this releasing operation, the drive motor 71 runs idly in the reverse rotational direction.

The ECU 29 clocks, in step S113, an elapsed time since the initiation of the aforementioned motor reverse rotation. In step S114, the ECU 29 reads in the elapsed time actually clocked in step S113. In step S115, the ECU 29 stands by for the actual elapsed time which reaches a predetermined time. Once the actual elapsed time becomes equal to, or greater than the predetermined time, the program proceeds to step S116, wherein the ECU 29 discontinues the activation of the drive motor 71 to rotate in the rotational direction for operating the slide door 1 to the open side. Here, this program is terminated.

Once the process to be implemented by the ECU 29 shifts to this routine illustrated in FIG. 7, the ECU 29 determines, in step S201, whether the ECU 29 has received output information of a door opening operation. More specifically, the ECU 29 determines the presence or absence (on or off) of an output signal of the operation switch 21, the signals which represent requirements of opening and closing of the slide door 1. When the ECU 29 receives the output signal of the operation switch 21, the program proceeds to step S202, wherein a latch release operation is implemented. That is, the ECU 29 controls a driving of the latch release actuator 27 for unlocking the lock device 31 and for shifting the slide door 1 from the fully closed position to the half-open position. At or about the same time, the ECU 29 engages the electromagnetic clutch device 20. That is, the ECU 29 electrically energizes or distributes electric power to the electromagnetic coil 15 of the electromagnetic clutch device 20 and brings the rotor 14 and the armature 13 to the connected state (disconnected→connected).

The ECU 29 then activates, in step S203, the drive motor 71 to implement an opening operation of the slide door 1. That is, the ECU 29 activates the drive motor 71 to rotate in a rotational direction for opening the slide door 1.

In the course of the opening operation of the slide door 1 in response to the activation of the drive motor 71, the ECU 29 stands by, in step S204, for detection of a low rotational speed by the speed sensor 25 (i.e., an opening operation of the slide door 1 at a low speed) or for turning on of the full open lock switch 26. That is, the ECU 29 stands by, in step S204, recognition of the slide door 1 that reached the fully open position. Once the ECU 29 receives the detection of the low rotational speed or the turning on of the full open lock switch 26, the program proceeds to step S205, wherein the ECU 29 discontinues activation of the drive motor 71, the driving which is employed for opening the slide door 1. The ECU 29 then disengages the electromagnetic clutch device 20 in step S206. That is, the ECU 29 discontinues or terminates electric energizing or electric power distribution to the electromagnetic coil 15 and controls the rotor 14 and the armature 13 at the disconnected state (connected→disconnected).

As described above, through steps S204, S205 and S206, after the detection of the low rotational speed or the turning on of the full open lock switch 26 (step S204), the ECU 29 terminates the driving of the drive motor 71 (step S205) and disengages the electromagnetic clutch device 20 (step S206). Alternatively or in addition, the ECU 29 can terminate the driving of the drive motor 71 after the detection of the low speed rotation by the speed sensor 25, and afterwards can disengage the electromagnetic clutch device 20 after the turning on of the full open lock switch 26.

When the slide door 1 reaches the fully open position, the ECU 29 controls, in step S207, the drive motor 71 to rotate in a reverse rotational direction. That is, the ECU 29 controls the drive motor 71 to rotate for operating the slide door 1 towards a closed side. Here, the reverse rotation of the drive motor 71 is carried out, inter alia, for the purpose of releasing the rotor 14 and the armature 13 from the connected state, the connected state which may have been maintained due to influences of remanent magnetic flux. Apart from this releasing operation, the drive motor 71 runs idly in the reverse rotational direction.

The ECU 29 clocks, in step S208, an elapsed time since the initiation of the aforementioned motor reverse rotation. In step S209, the ECU 29 reads in the elapsed time actually closed in step S208. In step S210, the ECU 29 stands by for the actual elapsed time which reaches a predetermined time. Once the actual elapsed time becomes equal to, or greater than the predetermined time, the program proceeds to step S211, wherein the ECU 29 discontinues the driving of the drive motor 71 to rotate in the rotational direction for operating the slide door 1 to the closed side. Here, this program is terminated.

As described above, according to the embodiment of the present invention, at least the following effects can be achieved.

(1) After activating the drive motor 71 so as to implement one of the opening and closing operation of the slide door 1, the ECU 29 interrupts electric power supplying to the electromagnetic coil 15 and then activates the drive motor 71. When the drive motor 71 is driven so as to implement the one of the opening and closing operations of the slide door 1, the electromagnetic coil 15 of the electromagnetic clutch device 20 is electrically energized so as to transmit a driving force between the drive motor 71 and the slide door 1. In this case, the rotor 14 and the armature 13 are connected to each other or brought into the connected state in favor of magnetic flux formed by the electromagnetic coil 15. Because the electromagnetic coil 15 is integrated with the rotor 14, even after discontinuing the electric energizing or electric power distribution to the electromagnetic coil 15, the rotor 14 and the armature 13 are maintained at the connected state due to remanent magnetic flux. However, according to the embodiment of the present invention, the rotor 14 and the armature 13 are released from the connected state by driving the drive motor by interrupting power supply to the electromagnetic coil 15 later on. Therefore, according to the embodiment of the present invention, when the slide door 1 is opened or closed after implementing the one of the electric-powered opening and closing operations of the slide door 1, the rotor 14 and the armature 13 are already at the disconnected state. Therefore, it is possible to prevent a manual operation force of the slide door 1 from unnecessarily increasing and to prevent an operation feeling, which is obtained by an operator, from being damaged.

(2) After activating the drive motor 71 so as to implement one of the opening and closing operations of the slide door 1, the ECU 29 interrupts electric power supplying to the electromagnetic coil 15 and then activates the drive motor 71 so as to implement the other one of the opening and closing operations of the slide door 1. That is, the connected state between the rotor 14 and the armature 13, which is maintained due to remanent magnetic flux after terminating the electric energizing of the electromagnetic coil 15, is interrupted or released by rotating the drive motor 71 in a reverse rotational direction corresponding to a reverse operation of the slide door 1. Therefore, remanent load (creep load), which on occasions occurs at the one of the opening and closing operations of the slide door 1 and is applied to mechanically engagement elements associated with a driving force transmission between the drive motor 71 and the slide door 1, can be effectively reduced. For example, remanent load, which is applied to a gear unit configuring the speed reduction mechanism of the actuator 7, i.e., a gear-meshed portion between the worm gear 71a and the wheel gear 12, can be effectively reduced. Moreover, for example, remanent load, which is applied to cables and so on that transmit a driving force from the output drum 72 to the slide door 1, can be effectively reduced. Accordingly, it is possible to enhance a durability of the gear unit for example and a durability of the vehicle door opening and closing apparatus.

(3) The rotor 14 and the electromagnetic coil 15 are integrally provided. Therefore, it is possible to eliminate an airgap, which is required at a time that the electromagnetic coil 15 is provided inside the rotor 14 (e.g., the coil 15 wound at a core) and is formed between the rotor 14 and the electromagnetic coil 15 to allow the rotor 14 to revolve freely, and to reduce magnetic loss. It is further possible to enhance a transmitting torque of the electromagnetic clutch device 20 and to downsize the electromagnetic coil 15 in response to improvement in a magnetic efficiency.

(4) It is possible to enhance an operability to-manually open and close the slide door 1 after electrically powered operation of the opening and dosing operation thereof

The following modifications can be applicable.

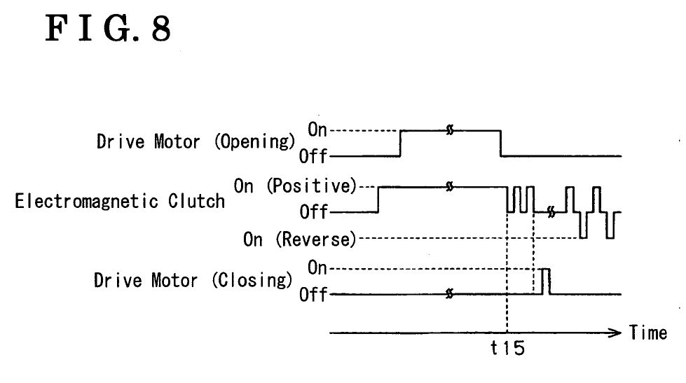

As illustrated in FIG. 8, after the shift of the slide door 1 to the fully open condition at time t15 and before driving the drive motor 71 so as to operate the slide door I in a closing direction (in a reverse direction), alternatively or in addition, the electromagnetic clutch device 20 (the electromagnetic coil 15) can be applied with electric current intermittently (off and on). In this case, it is possible to prevent the slide door 1 from jumping back when the slide door 1 reaches the fully open position.

Alternatively or in addition, as illustrated in FIG. 8, the electromagnetic clutch device 20 (the electromagnetic coil 15) can be applied with a drive signal, of which polarity can be inverted, further periodically. In this case, it is possible to demagnetize or attenuate remanent magnetic flux of the electromagnetic clutch device 20 effectively.

According to the embodiment of the present invention, a driving of the drive motor 71, which is implemented so as to release the connected state between the rotor 14 and the armature 13, is carried out after the slide door 1 has reached the fully open position or the fully closed position. Alternatively or in addition, such activation of the drive motor 71 can be implemented at any time such as when the slide door 1 is positioned at any given opening/closing position, after terminating an electric-powered opening/closing operation of the slide door 1.

According to the embodiment of the present invention, after terminating an electric-powered opening/closing operation of the slide door 1, the drive motor 71 is driven in a rotational direction, which is opposite to a rotational direction that had been carried out up to then, for the purpose of disconnecting the rotor 14 and the armature 13. Such driving of the drive motor 71 for the purpose of disconnecting the rotor 14 and the armature 13 can be carried out in the same rotational direction as the rotational direction that had been carried out up to then.

The ECU 29 can determine the requirement of an opening/closing operation of the slide door 1 on the basis of a condition of a switch that detects the presence or absence of an operation of a door handle (an inside/outside door handle) of the slide door 1. If a transmitter, which enables to operate the slide door 1 wirelessly, is provided, the ECU 29 can determine the requirement of an opening/closing operation of the slide door on the basis of an output signal of the transmitter.

The electromagnetic coil 15 can be embedded in the rotor 14 so as not to be exposed.

The frictional plate of the rotor 14 can be laid at the armature 13. Even if this frictional plate is not provided, it is possible to frictionally engage the rotor 14 and the armature 13.

According to the embodiment of the present invention, the electromagnetic clutch device 20 is engaged by generating the connected state, in which the rotor 14 and the armature 13 are frictionally engaged with each other. Alternatively or in addition, the electromagnetic clutch device 20 can be engaged by generating the connected state, in which teeth of the rotor 14 are mechanically engaged with teeth of the armature 13.

The above-described structure of the power supply mechanism 16 is one of examples. For example, as disclosed in JP2001-41263A, the power supply mechanism 16 can be provided with a brush and a slip ring that slidably comes in contact with the brush.

The drive unit 6 is employed for operating the slide door 1, according to the embodiment of the present invention. However, the drive unit 6 can serve for operating a swing door for example. Moreover, the drive unit 6 can be employed for operating not only a door attached to a side surface of the vehicle body 2 but also a door such as a tailgate (a back door) and a trunk lid.

The principles, the preferred embodiment and mode of operation of the present invention have been described in the foregoing specification. However, the invention, which is intended to be protected, is not to be construed as limited to the particular embodiment disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents that fall within the spirit and scope of the present invention as defined in the claims, be embraced thereby.

1. A vehicle door opening and closing apparatus comprising:
an electric driving power source generates a driving force that performs an opening and closing operation of a vehicle door;
an electromagnetic clutch device provided between the vehicle door and the electric driving power source, and selectively performs and interrupts a driving force by the electric driving power source transmitting to the vehicle door, the electromagnetic clutch device comprising;
a rotor;
an electromagnetic coil integrated with the rotor; and
an armature, and
a controlling means for controlling the driving power source and the electromagnetic clutch device,
wherein, when the controlling means interrupts electric power supplying to the electromagnetic coil, the rotor and the armature are controlled at a disconnected state, in which the driving force transmission is interrupted between the electric driving power source and the vehicle door and a manual opening and closing operation of the vehicle door is allowed, and when the controlling means supplies electric power to the electromagnetic coil, the rotor and the armature are controlled at a connected state, in which the driving force transmission between the electric driving power source and the vehicle door is performed, and wherein, after establishing the connected state, the controlling means interrupts power supply to the electromagnetic coil and activates the electric driving power source.

2. A vehicle door opening and closing apparatus according to claim 1, wherein the controlling means activates the electric driving power source in one of a direction for opening the vehicle door and a direction for closing the vehicle door.

3. A vehicle door opening and closing apparatus according to claim 1, wherein the electromagnetic clutch device includes a rotational shaft rotatable integrally with the rotor, and the electromagnetic coil is connected to a wire harness that is wound about the rotational shaft.

4. A vehicle door opening and closing apparatus according to claim 2, wherein the electromagnetic clutch device includes a rotational shaft rotatable integrally with the rotor, and the electromagnetic coil is connected to a wire harness that is wound about the rotational shaft.

5. A vehicle door opening and closing apparatus according to claim 1, wherein the electric driving power source is a motor, and a rotational speed of the motor is reduced when a worm gear fixed to a rotational shaft of the motor is meshed with a wheel gear freely rotatably supported about the rotational shaft which is rotatable integrally with the rotor.

6. A vehicle door opening and closing apparatus according to claim 2, wherein the electric driving power source is a motor, and a rotational speed of the motor is reduced when a worm gear fixed to a rotational shaft of the motor is meshed with a wheel gear freely rotatably supported about the rotational shaft which is rotatable integrally with the rotor.

7. A vehicle door opening and closing apparatus according to claim 3, wherein the electric driving power source is a motor, and a rotational speed of the motor is reduced when a worm gear fixed to a rotational shaft of the motor is meshed with a wheel gear freely rotatably supported about the rotational shaft which is rotatable integrally with the rotor driving power source.
